(19) United States
(12) Patent Application Publication
(10) Pub. No.: US 2020/0288210 A1
(43) Pub. Date: Sep. 10, 2020

(54) DISPLAY DEVICE AND CONTROL METHOD THEREFOR

(71) Applicant: SAMSUNG ELECTRONICS CO., LTD., Suwon-si (KR)

(72) Inventor: Yong-cheol YANG, Suwon-si (KR)

(73) Assignee: SAMSUNG ELECTRONICS CO., LTD., Suwon-si (KR)

(21) Appl. No.: 16/753,868

(22) PCT Filed: Oct. 22, 2018
(86) PCT No.: PCT/KR2018/012459

§ 371 Date: Apr. 6, 2020

(30) Foreign Application Priority Data
Oct. 26, 2017 (KR) 10-2017-0140476

(51) Int. Cl. H04N 21/6334; G06F 21/44; G09G 3/20; H04N 21/443

(52) U.S. Cl. CPC H04N 21/63345; G06F 21/445; G09G 2358/00; H04N 21/4435; G09G 3/20

(57) ABSTRACT

A display apparatus with a processor is configured to: store data of a first operating system (OS), a second OS and a third OS in a first area, a second area and a third area of a memory, respectively, and restrict access of the first OS to the data stored in the second area and access of the first OS and the second OS to the data stored in the third area; receive content from an external apparatus based on execution of the first OS, and receive authentication information of the content from the external apparatus based on execution of the second OS; and authenticate the content based on the received authentication information based on execution of the third OS, and control the content to be processed.

### TECHNICAL FIELD

The disclosure relates to a display apparatus and a control method thereof, and more particularly to a display apparatus, in which an execution environment for protecting data requiring security is implemented, and a control method thereof.

### BACKGROUND ART

An operating system (OS) generally installed in a display apparatus is a rich OS for executing a common application program, and a trusted OS is additionally installed in an application domain that requires an application program to be executed at a high security level.

An execution environment for the rich OS provides various libraries, device drivers, etc. needed to execute the common application program, whereas an execution environment for the trusted OS typically provides only functions essential for protecting important information.

For example, an application program for reproducing paid content, is executable under the execution environment of the rich OS, and the paid content is distributed as mostly encrypted. A security program for decrypting the encrypted paid content is typically required to be executed under the execution environment of the trusted OS.

In other words, a security system, for example, digital rights management (DRM) or a conditional access system (CAS) works in the execution environment of the trusted OS, and at this time a decryption key and decrypted content to be handled in the trust OS are protected by hardware not to be accessed by the rich OS.

However, the trusted OS does not generally have functions of communication, input/output (I/O), etc. because it employs a dedicated OS having small functions for protecting important information assets, such as key handling, memory allocation, video content protection, etc.

Therefore, when there is a need of receiving key information about a license of paid content from an external storage apparatus such as a secure content storage association (SCSA) hard disk drive (HDD), it is impossible for the trusted OS having no I/O functions for the HDD to directly access the external storage apparatus.

In this case, the rich OS can access the external storage apparatus and receive the key information of the paid content, but an I/O message for obtaining the key information and this event may be unprotected and exposed to the outside.

Further, when the rich OS communicates with a license server to receive a license for paid content, there is concern that session keys of a secure sockets layer (SSL) and transport Layer security (TLS) which need security are exposed.

### TECHNICAL PROBLEM

Accordingly, an aspect of the disclosure is to provide a display apparatus and a control method thereof, in which an execution environment of preventing security data input/output (I/O) related to content or an event itself from being exposed is implemented in terms of reproducing the content stored in an external storage apparatus.

Further, another aspect of the disclosure is to provide a display apparatus and a control method thereof, in which execution environments different in a security level according to required functions are implemented.

### TECHNICAL SOLUTION

According to an embodiment of the disclosure, there is provided a display apparatus with a processor configured to: store data of a first operating system (OS), a second OS and a third OS in a first area, a second area and a third area of a memory, respectively, and restrict access of the first OS to the data stored in the second area and access of the first OS and the second OS to the data stored in the third area; receive content from an external apparatus based on execution of the first OS, and receive authentication information of the content from the external apparatus based on execution of the second OS; and authenticate the content based on the received authentication information based on execution of the third OS, and control the content to be processed.

According to such an embodiment of the disclosure, an execution environment is established to prevent flow of security data related to the content from leaking, in terms of reproducing the content stored in the external storage apparatus. Further, it is possible to establish execution environments different in a security level according to required functions.

The processor may be configured to execute a first module to generate a virtual apparatus by virtualizing the external apparatus, and access the external apparatus and the virtual, apparatus by the first OS and the second OS. Thus, the same virtual apparatus as the physical storage apparatus is generated to distinguish between the OS for receiving the content and the OS for receiving the security data of the content, thereby preventing the flow of the security data from leaking.

The processor may be configured to execute a second module to control execution among the first OS, the second OS and the third OS. Thus, it is possible to control each OS, so that the OSs different in the security level from one another can be executed according to requested functions.

The second OS may include a device driver to access the external apparatus. Thus, an independent intermediate OS between the rich OS and the trusted OS can have access to the external apparatus, and it is possible to achieve an OS having a function to protect flow of information that needs security.

The display apparatus may further include a communicator configured to communicate with a server, wherein the processor is configured to execute the second OS to receive the authentication information from the server, and store the received authentication information in the external apparatus. Thus, when the external storage apparatus has no licenses for the content and thus obtains the license from the server, this event and flow of information are prevented from being exposed to the first OS during a process of obtaining the license.

The authentication information is updated with new authentication information received from the server. Thus, when the license stored in the external storage apparatus has expired, the updated license may be received again from the server based on a user's authority to use the content.

The processor may be configured to store the received content in the first area, store the received authentication information in the second area, and decrypt, and decode the content stored in the first area based on the authentication information stored in the second area. Thus, the content and the license information are stored in the memory areas different in an accessible OS, and thus the content is reproduced without leaking the flow and event of the license information that needs the security.

The processor may be configured to receive an interrupt request from each OS as divided into a virtual interrupt request and a physical interrupt request, and perform a process by executing OSs respectively corresponding to the virtual interrupt request and the physical interrupt request. Thus, it is possible to process the interrupt requests respectively corresponding to the OSs different in the security level.

According to an embodiment of the disclosure, there is provided a computer program product including: a first memory configured to store a plurality of instructions; and a processor, wherein the instruction is executed by the processor to store data of a first operating system (OS), a second OS and a third OS in a first area, a second area and a third area of a second memory, respectively, and restrict access of the first OS to the data stored in the second area and access of the first OS and the second OS to the data stored in the third area, and authenticate the content based on the received authentication information based on execution of the third OS, and control the content to be processed, by receiving content from an external apparatus based on execution of the first OS, and receiving authentication information of the content the external apparatus based on execution of the second OS.

According to such an embodiment of the disclosure, an execution environment is established to prevent flow of security data related to the content from leaking, in terms of reproducing the content stored in the external storage apparatus. Further, it is possible to establish execution environments different in a security level according to required functions.

The instruction may include executing a first, module to generate a virtual apparatus by virtualizing the external apparatus, and accessing the external apparatus and the virtual apparatus by the first OS and the second OS. Thus, the same virtual apparatus as the physical storage apparatus is generated to distinguish between the OS for receiving the content and the OS for receiving the security data of the content, thereby preventing the flow of the security data from leaking.

According to an embodiment of the disclosure, there is provided a method of controlling a display apparatus, including: storing data of a first operating system (OS), a second OS and a third OS in a first area, a second area and a third area of a memory, respectively; restricting access of the first OS to the data stored in the second area and access of the first OS and the second OS to the data stored in the third area; receiving content from an external apparatus based on execution of the first OS, and receiving authentication information of the content based on execution of the second OS; and authenticating the content based on the received authentication information based on execution of the third OS, and controlling the content to be processed.

According to such an embodiment of the disclosure, an execution environment is established to prevent flow of security data related to the content, from leaking, in terms of reproducing the content stored in the external storage apparatus. Further, it is possible to establish execution environments different in a security level according to required functions.

The method may further include executing a first module to generate a virtual apparatus by virtualizing the external apparatus, and accessing the external apparatus and the virtual apparatus by the first OS and the second OS. Thus, the same virtual apparatus as the physical storage apparatus is generated to distinguish between the OS for receiving the content and the OS for receiving the security data of the content, thereby preventing the flow of the security data from leaking.

The method may further include executing a second module to control execution among the first OS, the second OS and the third OS. Thus, it is possible to control each OS, so that the OSs different in the security level from one another can be executed according to requested functions.

The second OS may include a device driver to access the external apparatus. Thus, an independent intermediate OS between the rich OS and the trusted OS can have access to the external apparatus, and it is possible to achieve an OS having a function to protect flow of information that needs security.

The method may further include: communicating with a server; executing the second OS to receive the authentication information from the server; and storing the received authentication information in the external apparatus. Thus, when the external storage apparatus has no licenses for the content and thus obtains the license from the server, this event and flow of information are prevented from being exposed to the first OS during a process of obtaining the license.

The method may further include updating the authentication information with new authentication information received from the server. Thus, when the license stored in the external storage apparatus has expired, the updated license may be received again from the server based on a user's authority to use the content.

The method may further include storing the received content in the first area, and storing the received authentication information in the second area; and decrypting and decoding the content stored in the first area based on the authentication information stored in the second area. Thus, the content and the license information are stored in the memory areas different in an accessible OS, and thus the content is reproduced without leaking the flow and event of the license information that needs the security.

The method may further include receiving an interrupt request from each OS as divided into a virtual interrupt request and a physical interrupt request; and performing a process by executing OSs respectively corresponding to the virtual interrupt request and the physical interrupt request. Thus, it is possible to process the interrupt requests respectively corresponding to the OS s different in the security level.

### ADVANTAGEOUS EFFECTS

As described above, according to the disclosure, an execution environment is established to prevent security data related to content from leaking and further prevent flow of security data from exposure, in terms of reproducing the content stored in the external storage apparatus.

Further, according to the disclosure, it is possible to establish execution environments different in a security level according to required functions, and an isolated execution environment.

### ADVANTAGEOUS EFFECTS

As described above, according to the disclosure, an execution environment is established to prevent security data related to content from leaking and further prevent flow of security data from exposure, in terms of reproducing the content stored in the external storage apparatus.

Further, according to the disclosure, it is possible to establish execution environments different in a security level according to required functions, and an isolated execution environment.

### DESCRIPTION OF DRAWINGS

FIG. 1 is a block diagram of a display apparatus according to an embodiment of the disclosure.

FIG. 2 is a flowchart showing a method of controlling a display apparatus according to an embodiment of the disclosure

FIG. 3 illustrates interfaces between elements to authenticate content by receiving authentication information about the content from an external apparatus according to an embodiment of the disclosure.

FIG. 4 illustrates interfaces between elements to authenticate content when authentication information about the content is not stored in an external apparatus

FIG. 5 illustrates a configuration of operating systems (OS) different in a security level according to an embodiment of the disclosure.

FIG. 6 illustrates areas of a memory, which are different in accessible OS, according to an embodiment of the disclosure

FIG. 7 shows a table of tabulating services and applications executed in OSs according to an embodiment of the disclosure.

FIG. 8 illustrates interfaces for processing an interrupt request from OSs according to an embodiment of the disclosure.

FIG. 9 illustrates that a first module and a second module are executed to process a virtual interrupt request and a physical interrupt request according to an embodiment of the disclosure.

### BEST MODE

Below, embodiments of the disclosure will be described in detail to be easily carried out by a person having an ordinary skill in the art, to which the disclosure pertains, with reference to the accompanying drawings. The disclosure may be embodied in many different forms, and not limited to the embodiments set forth herein.

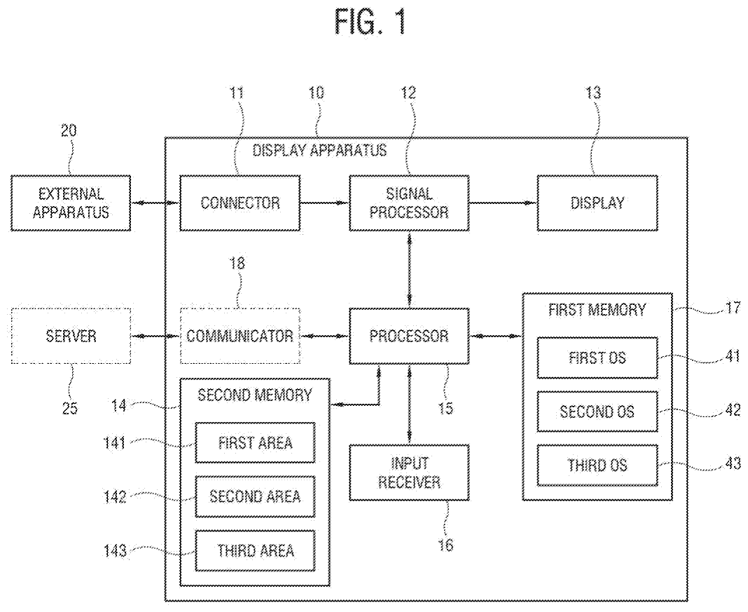

FIG. 1 is a block diagram of a display apparatus according to an embodiment of the disclosure. As shown in FIG 1, a display apparatus 10 according to the disclosure includes a connector 11, a signal processor 12, a display 13, a first memory 17, a second memory 14, a processor 15 and an input receiver 16, and may further include a communicator 18. The display apparatus 10 may connect with an external apparatus 20 through the connector 11, and communicate with a server 25 through the communicator 18. The display apparatus 10 may for example be embodied by a television (TV). The elements included in the display apparatus 10 are not limited to those according to this embodiment of the disclosure, but may execute some elements or include other additional elements.

To provide a plurality of implementable functions, the display apparatus 10 executes application programs respectively corresponding to the functions. For example, the display apparatus 10 executes a common application program in an execution environment of a rich operating system (OS) having a low security level, and executes an application program for a security system such as digital rights management (DRM) or a conditional access system (CAS) in an execution environment of a trusted OS having a high security level.

However, for example, in a case of receiving and reproducing paid content from an external storage apparatus such as a secure content storage association (SCSA) hard disk drive (HDD), when data exchange is performed by accessing the HDD in the execution environment of the rich OS having the low security level, information which needs security like a license of the paid content may be exposed to the outside. Meanwhile, the trusted OS having the high security level cannot access the HDD because a device driver is not given.

Therefore, the display apparatus 10 with the foregoing configuration according to the disclosure may for example additionally provide an execution environment of a ‘protected OS’, which not only supports communication, input/output (I/O) and the like functions but also is capable of protecting data that needs security, in addition to the rich OS and the trusted OS.

The connector 11 connects with the external apparatus 20 and includes a connection terminal for wired-connection with the external apparatus 20. The connector 11 may for example be embodied in the form of high-definition multimedia interface consumer electronics control (HDMI-CEC). The display apparatus 10 may receive and reproduce an image signal of content stored in the external apparatus 20 through the connector 11. In this case, the display apparatus 10 may receive not only the image signal of the content but also authentication information, e.g. a license for using the paid content through the connector 11. Here, the license includes key information and use information about the paid content.

The signal processor 12 performs a preset signal process with respect to an image signal of content received through the connector 11. As an example of the signal process performed in the signal processor 12, there are demultiplexing, decoding, de-interlacing, scaling, noise reduction, detail enhancement, etc. and there are no limits to the kind of signal process. The signal processor 12 may be embodied by a system-on-chip (SOC) where such various functions are integrated, or an image processing board in which individual elements for independently performing the processes are mounted.

The display 13 displays an image based on an image signal of content processed by the signal processor 12. Because there are no limits to the type of the display 13, the display 13 may be embodied in various types such as a plasma display panel (PDP), a liquid crystal display (LCD), an organic light emitting diode (OLED), a flexible display, etc.

The communicator 18 communicates with the server 25, which is storing authentication information, for example a license for using a plurality of pieces of paid content, through wired or wireless communication. The communicator 18 may communicate with an external apparatus 20 by Ethernet or the like wired communication method, or may communicate with an external apparatus 20 through a wireless router by Wi-Fi, Bluetooth or the like wireless communication method. For example, the communicator 18 may be provided as a printed circuit board (PCB) with a module for wireless communication such as Wi-Fi. The communication method of the communicator 18 is not limited to the foregoing example, and may include other communication methods to communicate with the external apparatus 20.

The first memory 17 is embodied by a nonvolatile memory such as a flash memory to retain data regardless of whether the display apparatus 10 is powered on or off.

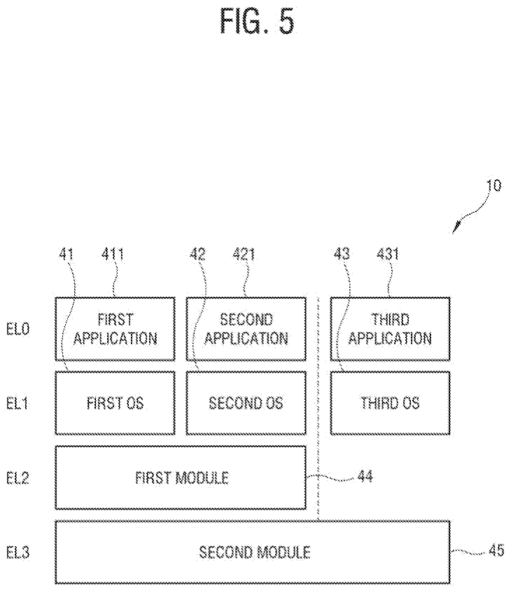

The first memory 17 is configured to store a first OS 41, a second OS 42 and a third OS 43 different in a security level from one another as the OS for the display apparatus 10. Further, the first memory 17 is configured to store an application program executable by each OS, for example, all of a first application (see ‘411’ in FIG. 5) to be executed by the first OS 41, a second application (see ‘421’ in FIG. 5) to be executed by the second OS 42, and a third application (see ‘431’ in FIG. 5) to be executed by the third OS 43.

Further, the first memory 17 is configured to store a first module (see ‘44’ in FIG. 5) and a second module (see ‘45’ in FIG. 5) for controlling the OS. The first module 44 virtualizes the external apparatus 20 so as to be accessed by the first OS and the second OS, and the second module 45 controls the execution among the first OS 41, the second OS 42 and the third OS 43.

As described above, the first memory 17 is configured to store a plurality of instructions to execute each OS, each application, and the programs of the first module and the second module. The first memory 17 is configured to perform reading, writing, editing, deleting, updating, etc. with regard to the plurality of stored instructions.

The second memory 14 may for example be embodied by a random-access memory (RAM) as an area to store data or program instructions frequently accessed by the processor 15 red to be immediately used without repetitive retrieval.

The second memory 14 includes a first area 141, a second area 142 and a third area 143, each of which is configured to store data as each OS stored in the first memory 17 is executed. In other words, the first area 141 is configured to store data of the first application 411 executed by the first OS 41, the second area 142 is configured to store data of the second application 421 executed by the second OS 42. Further, the third area 143 is configured to store data of the third application 431 executed by the third OS 43.

In this case, the first area 141, the second area 142 and the third area 143 are set to be different in the accessible OS from one another.

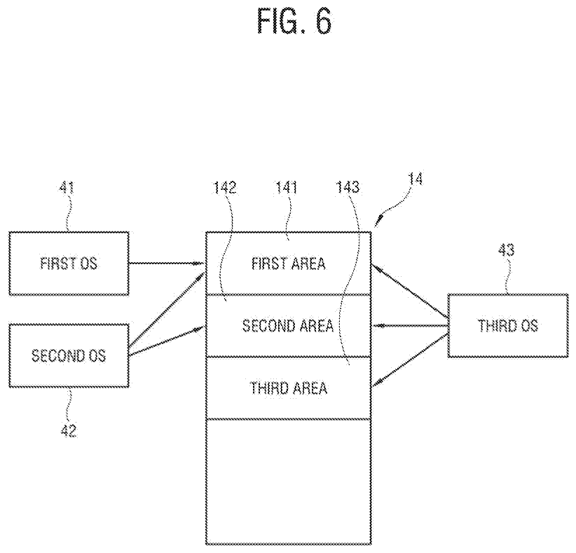

As shown in FIG. 6, the first area 141 may for example be set as a world shared memory (WSM) to be accessible by all of the first OS 41, the second OS 42 and the third OS 43. Further, the second area 142 may for example be set as a village shared memory (VSM) to be accessible by the second OS 42 and the third OS 43, and the third area 143 may for example be set as a secure memory to be accessible by only the third OS 43.

Because the second area 142 is shared only between the second OS 42 and the third OS 43, it is possible to prevent a flow and event of security data from being exposed by the first OS 41 while the security data received from the external apparatus 20 and stored by the second OS 42 is used by the third OS 43.

In this embodiment, the second memory 14 is provided as a separate element. However, this is merely an example of the disclosure. Alternatively, the second memory 14 may for example be integrated into the processor 15.

The input receiver 16 receives a user's input for controlling at least one function of the display apparatus 10. For example, the input receiver 16 may receive a user's input for selecting a part of a user interface displayed on the display 13. The input receiver 16 may be embodied in the form of an input panel provided on an outer side of the display apparatus 10 or a remote controller performing infrared-communication with the display apparatus 10. Further, the input receiver 16 may be embodied by a keyboard, a mouse, or the like connected to the display apparatus 10, and may also be embodied by a touch screen provided in the display apparatus 10.

The processor 15 performs a control process for controlling a plurality of functions performable by the display apparatus 10. The processor 15 may be embodied by a central processing unit (CPU), and include three areas of control, operation, and register. In the control area, a program instruction is interpreted, and the elements of the display apparatus 10 is instructed to operate based on meaning of the interpreted instruction. In the operation area, an arithmetic operation and a logical operation are performed, and operations necessary for operating the elements of the display apparatus 10 are performed as instructed in the control area. The register area refers to a memory area for storing necessary information while an instruction is executed in the CPU, and stores instructions and data related to the elements of the display apparatus 10 and operation results.

The processor 15 executes programs of the first OS 41, the second OS 42, and the third OS 43 stored in the first memory 17, and programs of the first module 44 and the second module 45. Below, operations of the processor 15 to execute the programs will be omitted if possible, and each program will be described as the subject of the operation.

When each of the first OS 41, the second OS 42 and the third OS 43 stored in the first memory 17 is executed, data generated by the execution is stored in each of the first area 141, the second area 142 and the third area 143 of the second memory 14.

The access of the first OS 41 to the data stored in the second area 142 is restricted, and the access of the first OS 41 and the second OS 42 to the data stored in the third area 143 is restricted.

In other words, the first OS 41 is prevented from accessing security-related data generated by the execution of the second OS 42 and the third OS 43, and not only the first OS 41 but also the second OS 42 are prevented from accessing data that is generated by the execution of the third OS 43 and needs the highest security level. Like this, the processor 15 may restrict the access to the data stored in each area of the second memory 14 based on a required security level.

When the first OS 41 is executed, the first OS 41 receives content from the external apparatus 20. When the second OS 42 is executed, the second OS 42 performs control to receive the authentication information of the content from the external apparatus 20. Here, the second OS 42 may include a device driver to have access to the external apparatus 20.

For example, when the external, apparatus 20 is provided as an SCSA HDD storing paid content, the SCSA HDD is configured to store the content and the authentication information of the content in different areas, respectively. In this case, the processor 15 receives the content and the authentication information respectively stored in the areas of the HDD through different OSs.

As described above, when the paid content from the SCSA HDD is received and reproduced, the first OS 41 having the lowest security level needs to be prevented from accessing the authentication information related to usage of the paid content because the authentication information corresponds to the security data that does not have to be exposed to the outside.

Thus, the first module (see ‘44’ in FIG. 5) stored in the first memory 17 is executed to generate a virtual apparatus (not shown) by virtualizing the external apparatus 20. Further, the external apparatus 20 and the virtual apparatus are respectively accessed by the first OS 41 and the second OS 42.

Here, the virtual apparatus is virtualized to have the same structure as the external apparatus 20, and embodied to have a virtual address without overlapping with an address that a storage area of the external apparatus 20 has. Thus, the first OS 41 and the second OS 42 are prevented from overlappingly accessing a specific address of the external apparatus 20, thereby preventing a resource conflict.

As described above, when the virtual apparatus is implemented by the first module 44, the processor 15 accesses the external apparatus 20 based on execution of the first OS 41 to receive content from the external apparatus 20, and accesses the virtual apparatus based on execution of the second OS 41 to receive the authentication information of the content from the virtual apparatus. In other words, the authentication information of the content, which needs security, is received by the second OS 42 having a higher security level than the first OS 41, and it is thus possible to prevent the authentication information of the content from being exposed to the outside.

Further, when the third OS 43 is executed, the third OS 43 authenticates content based on the authentication information of the content received from the second OS 42, and processes the content.

Specifically, the content received by the first OS 41 is stored in the first area 141 of the second memory 14, and the authentication information received by the second OS 42 is stored in the second area 142 of the second memory 14. In this case, the third OS 43 controls the signal processor 12 to decrypt the content stored in the first area 141 based on the authentication information stored in the second area 142, and decode the decrypted content to become reproducible.

According to an embodiment, the display apparatus 10 communicates with the server 25 through the communicator 18, and executes the second OS 42 to receive the authentication information of the content from the server 25. For example, when the authentication information of the content is not being stored in the SCSA HDD, the processor 15 may transmit a request for the authentication information to the server 25 and receive the authentication information. In this case, the authentication information of the content is received by the second OS 42 having the higher security level than the first OS 41 because the authentication information is the data that needs security.

Further, the second OS 42 stores the authentication information received from the server 25 in the external apparatus 20. Thus, in a case where it is desired to reproduce the paid content, when the authentication information is not being stored in the external apparatus 20 providing the content, the authentication information may be received from the server 25 and used in authenticating the content.

As described above, in terms of reproducing the content stored in the external apparatus 20, the display apparatus 10 according to the disclosure may establish an execution environment to prevent the flow and event of the security data related to the content from being exposed.

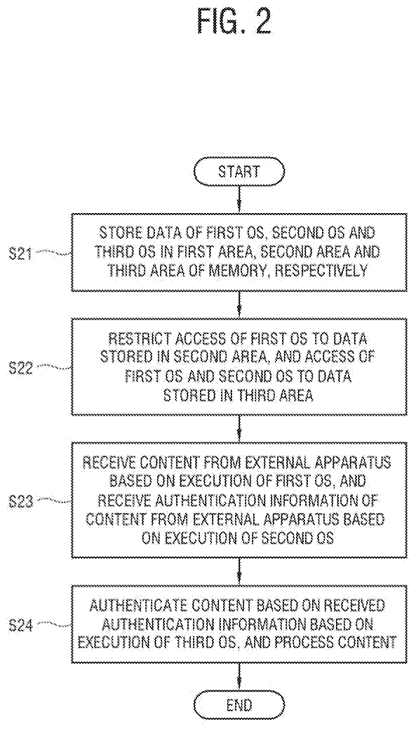

Specifically, the display apparatus 10 according to the disclosure may process the content stored in the external apparatus 20 based on flow of operations shown in FIG. 2, so as to reproduce the content.

First, at operation S21, the data of the first OS 41, the data of the second OS 42 and the data of the third OS 43 are stored in the first area 141, the second area 142 and the third area 143 of the memory, respectively. At operation S22, the access of the first OS 41 to the data stored in the second area 142 is restricted, and the access of the first OS 41 and the second OS 42 to the data stored in the third area 143 is restricted.

Next, at operation S23, the content is received from the external apparatus 20 based on the execution of the first OS 41, and the authentication information of the content is received from the external apparatus 20 based on the execution of the second OS 42. Here, the authentication information of the content includes key information and usage rules needed for decrypting the content.

Last, at operation S24, the content is authenticated based on the received authentication information and processed, based on the execution of the third OS 43. Here, the operation S24 may include operation of storing the received content in the first area 141 and storing the received authentication information in the second area 142, and operation of decrypting and decoding the content stored in the first area 141 based on the authentication information stored in the second area 142.

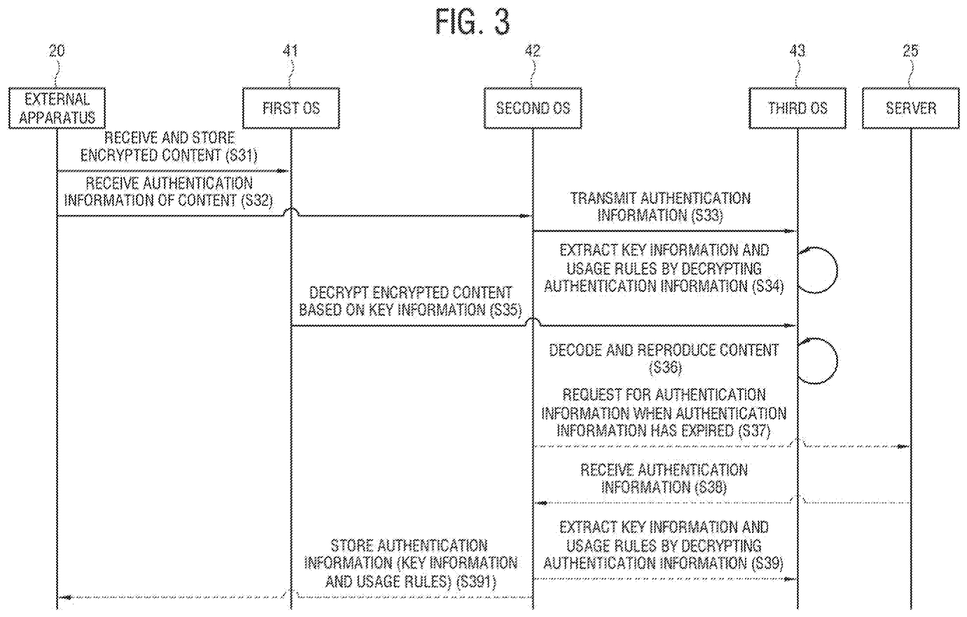

FIG. 3 illustrates interfaces between elements to authenticate content by receiving authentication information about the content from an external apparatus according to an embodiment of the disclosure. At operation S31, encrypted content is received from the external apparatus 20 by the first OS 41. In this case, the received content, is stored in the first area 141 of the second memory 14. The operation S31 does not need to be performed first of all, but has to be performed before operation S35 of performing authentication based on the authentication information of the content.

At operation S32, the authentication information of the content is received from the external apparatus 20 by the second OS 42. In this case, the received authentication information is stored in the second area 142 of the second memory 14.

At operation S33, the authentication information of the content is transmitted from the second OS 42 to the third OS 43. At operation S34, the authentication information received from the second OS 42 is decrypted by the third OS 43 to extract key information and usage rules of the content.

Next, at the operation S35, the encrypted content stored in the first area 141 in the operation S31 is decrypted by the third OS 43 based on the key information of the content extracted in the operation S34.

At operation S36, the decrypted content is decoded and reproduced by the third OS 43.

According to an embodiment, operation S37 to S391 may be additionally performed as optional operation subsequent to the operation S36.

At operation S37, when the authentication information of the content has expired, the second OS 42 transmits a request for the authentication information to the server 25. In this case, the operation S37 may include operation of transmitting information about usage authority to the server 25, and requesting for the authentication information corresponding to the transmitted use authority.

Next, at operation S38, the second OS 42 receives the authentication information from the server 25 and transmits the authentication information to the third OS 43. At operation S39, the third OS 43 decrypts the received authentication information and extracts the key information and usage rules of the content.

Next, at operation S391, the second OS 42 stores the authentication information including the key information and usage rules in the external apparatus 20.

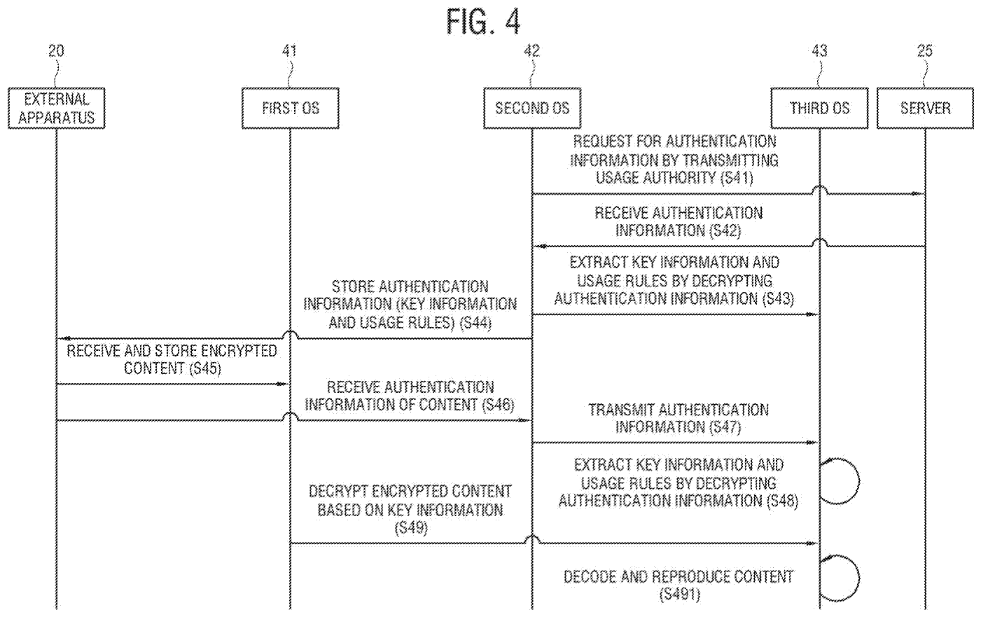

FIG. 4 illustrates interfaces between elements to authenticate content when authentication information about the content is not stored in an external apparatus. As shown in FIG. 4, when the authentication information of the content is not stored in the external apparatus 20, at operation S41, the second OS 42 first transmits information about usage authority to the server 25, and requests for the authentication information corresponding to the use authority.

At operation S42, the second OS 42 receives the authentication information from the server 25 and transmits the authentication information to the third OS 43.

Here, the second OS 42 employs a session key to protect a communication message about the transmission of the usage authority and the reception of the authentication information through a secure sockets layer (SSL) and transport layer security (TLS). In other words, the second OS 42 having a higher security level than the first OS 41 is used to prevent the session key from being exposed while communication with the server 25 is performed to receive the authentication information.

Next, at operation S43, the third OS 43 decrypts the received authentication information and extracts the key information and usage rules of the content.

At operation S44, the second OS 42 stores the authentication information including the key information and usage rules in the external apparatus 20.

At operation S45, the first OS 41 receives encrypted content from the external apparatus 20. In this case, the received content is stored in the first area 141 of the second memory 14.

At operation S46, the second OS 42 receives the authentication information of the content from the external apparatus 20, and stores the received authentication information in the second area 142 of the second memory 14.

At operation S47, the second OS 42 transmits the authentication information of the content to the third OS 43. At operation S43, the third OS 43 decrypts the authentication information received from the second OS 42 and extracts the key information and usage rules of the content.

Next, at operation S49, the third OS 43 decrypts the encrypted content stored in the first area 141 in the operation S46, based on the key information of the content extracted in the operation S48.

Last, at operation S491, the third OS 43 decodes and reproduces the decrypted content.

According to the foregoing embodiment of the disclosure, the display apparatus 10 establishes an execution environment in which the security is enhanced to prevent authentication information of paid content from being hacked, in terms of reproducing the paid content provided from an external storage apparatus such as the SCSA HDD.

FIG. 5 illustrates a configuration of OS different in a security level according to an embodiment of the disclosure. As shown in FIG. 5, the display apparatus 10 of the disclosure provides an execution environment for executing programs corresponding to a plurality of functions, in order to provide the functions.

In the illustrated configuration, the display apparatus 10 provides the first OS 41, the second OS 42 and the third OS 43, as OSs different in a security level. Here, the first OS 41 may be embodied by an OS in which a common application program is executable under an execution environment having the lowest security level, for example, by the rich OS.

On the other hand, the third OS 43 may be embodied by an OS in which a program for a security system such as the DRM or CAS is executable under an execution environment having the highest security level, for example, by the trusted OS.

The second OS 42 may be embodied by an OS in which data that needs security is protectable while supporting communication, I/O and the like functions under an execution environment having an intermediate security level between the first OS 41 and the third OS 43, for example, by the protected OS.

Meanwhile, an example of an application executable in each OS is as follows. The first application 411 refers to an application executable by the first OS 41, and may for example include a common client application, a web-based application, etc.

The second application 421 refers to an application executable by the second OS 42, and is called a demilitarized zone (DMZ) application. The second application 421 may for example include an application applied to Internet communication using a transmission control protocol (TCP)/Internet protocol (IP) network and protected TLS. The second application 421 is executed in the second OS 42 because the second application 421 needs security to prevent exposure of a session key used in communication.

The third application 431 refers to an application executable by the third OS 43, and includes an application for the security system such as the DBM or the CAS.

The display apparatus 10 stores the OSs and the applications respectively executable in the OSs in the flash memory, i.e. the first memory 17. Further, the display apparatus 10 stores the first nodule 44 and the second module 45 for controlling the execution of each OS in the first memory 17.

The first module 44 virtualizes the external apparatus 20 so as to be accessed by the first OS 41 and the second OS 42. The first module 44 may for example be embodied by a hypervisor. The hypervisor refers to a logical platform to execute a plurality of OSs at a time, and is also called a virtual machine monitor.

The first module 44 virtualizes the external apparatus 20 to generate a virtual apparatus, and executes the first OS 41 and the second OS 42 at the same time, thereby allowing the first OS 41 and the second OS 42 to respectively access the external apparatus 20 and the virtual apparatus.

For example, when paid content from the SCSA HDD is reproduced, the first OS 41 and the second OS 42 different in a security level from each other are executed to receive the content and the authentication information of the content, respectively. In this case, the first module 44 virtualizes the HDD so as to prevent a resource conflict as the first OS 41 and the second OS 42 have overlapping access to a specific address of the HDD.

As described above, the virtualizing operation of the first module 44 allows the OSs different in a security level from each other to have access to one physical storage apparatus.

The second module 45 controls the execution among the first OS 41, the second OS 42 and the third OS 43. The second module 45 may for example be embodied by a secure monitor program. The secure monitor program performs switching between the hypervisor and the third OS 43, and executes an instruction having the instruction having the highest authority, thereby controlling the execution of the first OS 41, the second OS 42 and the third OS 43. Here, the second module 45 has the higher execution authority than those of the first module 44, each application, the kernel of each OS, and the device driver.

In the illustrated elements, the execution levels of the elements become higher in order of each application, each OS, the first module 44 and the second module 45. In other words, the execution level EL1 of each OS is higher than the execution level EL0 of each application, and the execution level EL2 of the first module 44 is higher than the execution level EL1 of each OS.

The second module 45 has the execution level EL3 higher than the execution level EL2 of the first module 44, and therefore is given the highest execution authority to control the execution of each element.

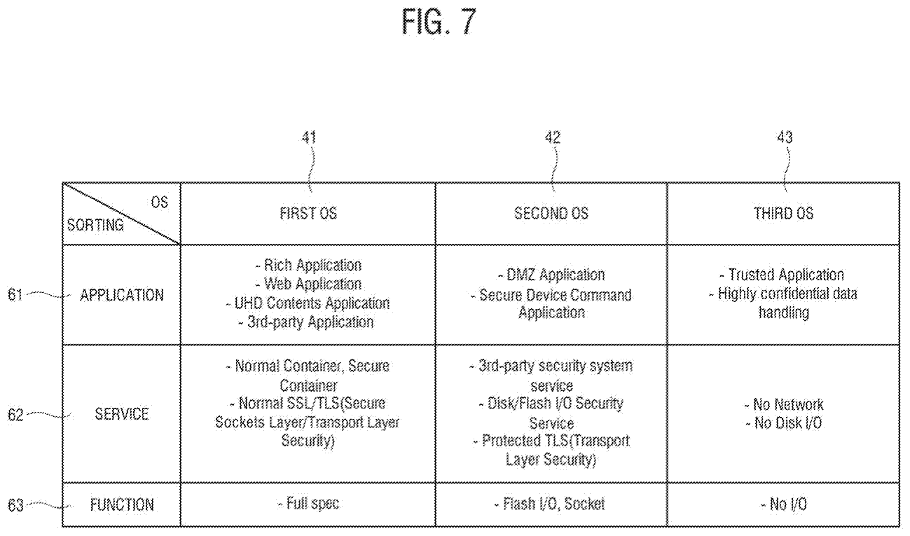

FIG. 7 shows a table of tabulating services and applications executed in OSs according to an embodiment of the disclosure. As shown in FIG. 7, the OSs are varied in executable application 61 and service 62 depending on their security levels, and their functions 63 may be restricted.

The first OS 41 can execute common applications, for example, a rich application, a web application, an ultra-high definition (UHD) content application, a 3^{rd}-party application, etc. under an execution environment having the lowest security level. The first OS 41 may use the foregoing applications to provide services, for example, a normal container storing a user's personal data, a secure container storing authentication and encrypted data, general SSL/TLS for network communication, etc. As described above, the first OS 41 provides an execution environment, in which common programs are executable without limitations of the providable function 63.

The third OS 43 is executed as completely isolated from the first OS 41, and provides an execution environment, having the highest security level. The third OS 43 can execute an application that, needs the highest security level, for example, a trusted application, an application for highly confidential data handling, etc. Further, the third OS 43 does not provide a network and disk I/O and the like service and function, thereby cutting off an interface with the external apparatus 20 and preventing the security data from leaking.

The second OS 42 provides an execution environment, of which the security level is higher than that of the first OS 41 but lower than that of the third OS 43, and interfaces with the first OS 41 or the third OS 43 according to functions desired to be performed. The second OS 42 can for example execute a DMZ application, a secure device command application, and the like that needs communication security. The second OS 42 may use the foregoing applications to provide services, for example, a 3^{rd}-party security system service, a disc/flash I/O security service, a trusted TLS, etc. As described above, the second OS 42 provides the flash I/O, a socket or the like function, thereby accessing the external apparatus 20 or communicating with the server 25.

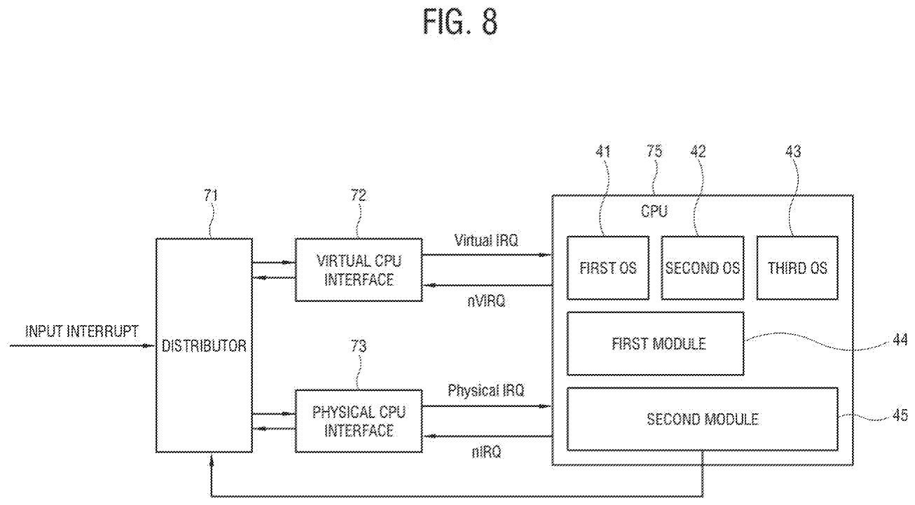

FIG. 8 illustrates interfaces for processing an interrupt request from OSs according to an embodiment of the disclosure. As shown in FIG. 8, the display apparatus 10 of the disclosure divides an input interrupt request into a virtual interrupt request Virtual IRQ and a physical interrupt request Physical IRQ and processes each interrupt, under the execution environment providing the first OS 41, the second OS 42 and the third OS 43.

As shown therein, a distributor 71 is used to distribute the input interrupt request to a virtual CPU interface 72 and a physical CPU interface 73, and the virtual interrupt request Virtual IRQ and the physical interrupt request Physical IRQ are transmitted to a CPU 75 through respective interfaces. Thus, the CPU 75 executes OSs respectively corresponding to the received virtual interrupt request and physical interrupt request, thereby performing an interrupt processing operation. Further, the CPU 75 outputs interrupt processing results nVIRQ and nIRQ to the virtual CPU interface 72 and the physical CPU interface 73.

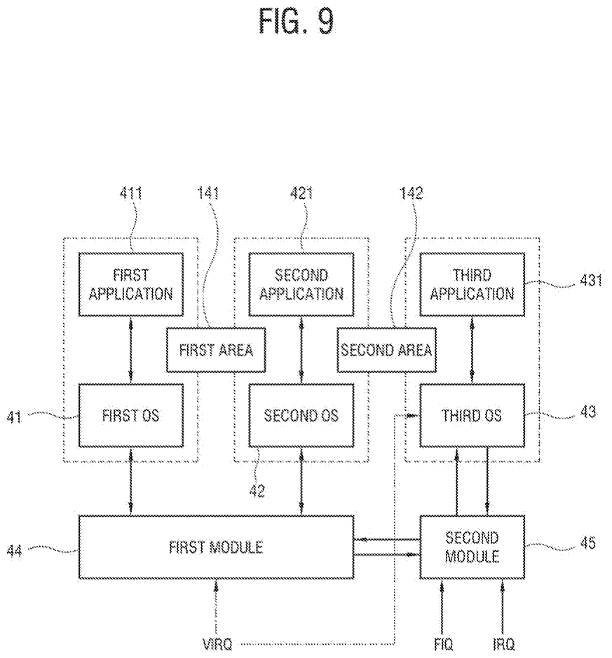

FIG. 9 illustrates that a first module and a second module are executed to process a virtual interrupt request and a physical interrupt request according to an embodiment of the disclosure. As shown in FIG. 9, the display apparatus 10 of the disclosure divides an input interrupt request into a virtual interrupt request Virtual IRQ and a physical interrupt request Physical IRQ, and executes the first module 44 and the second module 45 to respectively process the interrupt requests.

In the illustrated configuration, the first module 44 receives the input virtual interrupt request VIRQ, and performs an interrupt process through the first OS 41 and the second OS 42.

The second module 45 receives the input physical interrupt request, i.e. a fast interrupt request (FIQ) and interrupt request (IRQ), and executes the first module 44 and the third OS 43 to process the received interrupt request.

In this case, data transmitted and received while processing the virtual interrupt request and the physical interrupt request is stored in the first area 141 and the second area 142 of the second memory 14. The first area 141 is accessible by the first OS 41, the second OS 42 and the third OS 43, and the second area 142 is accessible by the second OS 42 and the third OS 43.

As described above, according to an embodiment of the disclosure, the first module 44 and the second module 45 having the high execution level are used to process the interrupt requests respectively corresponding to the OSs different in the security level.

A few embodiments of the disclosure have been described above in detail, but the disclosure is net limited to these embodiments and may be variously embodied without departing from the scope of the appended claims.

1. A display apparatus with a processor configured to:
store data of a first operating system (OS), a second OS and a third OS in a first area, a second area and a third area of a memory, respectively, and restrict access of the first OS to the data stored in the second area and access of the first OS and the second OS to the data stored in the third area;
receive content from an external apparatus based on execution of the first OS, and receive authentication information of the content from the external apparatus based on execution of the second OS; and
authenticate the content based on the received authentication information based on execution of the third OS, and control the content to be processed.

2. The display apparatus according to claim 1, wherein the processor is configured to execute a first module to generate a virtual apparatus by virtualizing the external apparatus, and access the external apparatus and the virtual apparatus by the first OS and the second OS.

3. The display apparatus according to claim 2, wherein the processor is configured to execute a second module to control execution among the first OS, the second OS and the third OS.

4. The display apparatus according to claim 1, wherein the second OS comprises a device driver to access the external apparatus.

5. The display apparatus according to claim 1, further comprising a communicator configured to communicate with a server, wherein
the processor is configured to execute the second OS to receive the authentication information from the server, and store the received authentication information in the external apparatus.

6. The display apparatus according to claim 5, wherein the authentication information is updated with new authentication information received from the server.

7. The display apparatus according to claim 1, wherein the processor is configured to store the received content in the first area, store the received authentication information in the second area, and decrypt and decode the content, stored in the first area based on the authentication information stored in the second area.

8. The display apparatus according to claim 1, wherein the processor receives an interrupt request from each OS as divided into a virtual interrupt request and a physical interrupt request, and performs a process by executing OSs respectively corresponding to the virtual interrupt request and the physical interrupt request.

9. A computer program product comprising:
a first memory configured to store a plurality of instructions; and
a processor,
wherein the instruction is executed by the processor to store data of a first operating system (OS), a second OS and a third OS in a first area, a second area and a third area of a second memory, respectively, and restrict access of the first OS to the data stored in the second area and access of the first OS and the second OS to the data stored in the third area, and
authenticate the content based on the received authentication information based on execution of the third OS, and control the content to be processed, by receiving content from an external apparatus based on execution of the first OS, and receiving authentication information of the content the external apparatus based on execution of the second OS.

10. The computer program product according to claim 9, wherein the instruction comprises executing a first module to generate a virtual apparatus by virtualizing the external apparatus, and accessing the external apparatus and the virtual apparatus by the first OS and the second OS.

11. A method of controlling a display apparatus, comprising:
storing data of a first operating system (OS), a second OS and a third OS in a first area, a second area and a third area of a memory, respectively;
restricting access of the first OS to the data stored in the second area and access of the first OS and the second OS to the data stored in the third area;
receiving content from an external apparatus based on execution of the first OS, and receiving authentication information of the content based on execution of the second OS; and
authenticating the content based on the received authentication information based on execution of the third OS, and controlling the content to be processed.

12. The method according to claim 11, further comprising executing a first module to generate a virtual apparatus by virtualizing the external apparatus, and accessing the external apparatus and the virtual apparatus by the first OS and the second OS.

13. The method according to claim 12, further comprising executing a second module to control execution among the first OS, the second OS and the third OS.

14. The method according to claim 11, wherein the second OS comprises a device driver to access the external apparatus.

15. The method according to claim 11, further comprising:
communicating with a server;
executing the second OS to receive the authentication information from the server; and
storing the received authentication information in the external apparatus.

16. The method according to claim 15, further comprising updating the authentication information with new authentication information received from the server.

17. The method according to claim 11, further comprising
storing the received content in the first area, and storing the received authentication information in the second area; and
decrypting and decoding the content stored in the first area based on the authentication information stored in the second area.

18. The method according to claim 11, further comprising
receiving an interrupt request from each OS as divided into a virtual interrupt request and a physical interrupt request; and
performing a process by executing OSs respectively corresponding to the virtual interrupt request and the physical interrupt request.
